(19) United States
(12) Patent Application Publication
(10) Pub. No.: US 2026/0015025 A1
(43) Pub. Date: Jan. 15, 2026

(54) Hub Type Energy Storage Mass Block Transport Device

(71) Applicant: Guizhou Power Grid Co., Ltd., Guiyang (CN)

(72) Inventors: Julong CHEN, Guiyang (CN); Zhen LI, Guiyang (CN); Yongqing ZHU, Guiyang (CN); Bin WANG, Guiyang (CN); Xueyong TANG, Guiyang (CN); Xuepeng MOU, Guiyang (CN); Yuxiang WANG, Guiyang (CN); Dameng LIU, Guiyang (CN); Chen LUO, Guiyang (CN); Zhaofeng ZHANG, Guiyang (CN); Yu ZHANG, Guiyang (CN); Qingsheng LI, Guiyang (CN); Wei WANG, Guiyang (CN)

(21) Appl. No.: 19/008,029

(22) Filed: Jan. 2, 2025

Related U.S. Application Data
(63) Continuation of application No. PCT/CN2024/135950, filed on Nov. 29, 2024.

(30) Foreign Application Priority Data
Jul. 15, 2024 (CN) 2024109436081

(51) Int. Cl. B62B 3/04

(52) U.S. Cl. CPC B62B 3/04; B62B 2203/60; B62B 2203/74

(57) ABSTRACT

The present invention discloses a hub type energy storage mass block transport device in the technical field of transportation of energy storage blocks. The hub type energy storage mass block transport device includes: a bearing unit, including a bearing part, including correction parts, two groups of guide parts, and a fixed frame; and a limiting unit, including a trigger part, a prying part and a locking part, where the fixed frame is slidingly connected below the locking part. According to the present invention, the hub type mass block can be effectively prevented from accidentally falling in the transportation process by limiting from three directions, and the safety in the transportation process can be ensured.

### CROSS-REFERENCE TO RELATED APPLICATIONS

The present application claims priority to Chinese Patent Application No. 2024109436081, filed on Jul. 15, 2024, the entire disclosure of which is incorporated herein by reference.

### TECHNICAL FIELD

The present invention relates to the technical field of transportation of energy storage blocks, and in particular to a hub type energy storage mass block transport device.

### BACKGROUND

When a gravity energy storage system uses a hub type mass block to generate electricity, an energy storage mass block moves from high to low along a cableway under the action of the gravity, or is dragged by a motor to rise along a track. This process includes three parts: mounting, transporting and unhooking, where the hub type mass block is required to be transported under the cooperation of a transfer trolley in the process of getting in and out of a stack.

In the prior art, since a roller wheel convenient to move is arranged below the hub type mass block, and the common transfer trolley for transportation can only have a single transportation function and lacks the measures of limiting and fixing the mass block, which easily causes the hub type mass block to slip off of the trolley, resulting in unnecessary fall damage to the hub type mass block, so that the safety of the hub type mass block in the transportation process cannot be effectively ensured.

### SUMMARY

In view of the problems in an existing hub type energy storage mass block transport device, the present invention is proposed.

Therefore, the present invention provides a hub type energy storage mass block transport device, so as to limit and fix a hub type mass block during transportation, prevent the hub type mass block from accidentally falling and ensure the transportation safety.

To solve the above technical problem, the present invention provides the following technical solution: a hub type energy storage mass block transport device includes: a bearing unit, including a bearing part located below a hub type mass block, correction parts symmetrically arranged on two sides of the bearing part, two groups of guide parts arranged on two sides above the bearing part, and a fixed frame arranged at an end of the bearing part; and a limiting unit, including a trigger part located between the two groups of guide parts, a prying part located on a side below the trigger part, a locking part vertically arranged on a side surface of the bearing part, two groups of limiting parts symmetrically distributed on two sides of the bearing part, and an unlocking part arranged on a side below the bearing part, the fixed frame being slidingly connected below the locking part, and a top end of the unlocking part abutting against an inner side of a tail end of the locking part.

As a preferred solution of the hub type energy storage mass block transport device according to the present invention, the bearing part includes a first bottom plate located between the two groups of correction parts, side edge plates symmetrically arranged on two sides of the first bottom plate, a guide plate arranged at one end of the first bottom plate and a second bottom plate arranged at the other end of the first bottom plate, where the correction parts are mounted between the first bottom plate and the side edge plates.

As a preferred solution of the hub type energy storage mass block transport device according to the present invention, each of the correction parts includes a correction assembly located between the first bottom plate and the side edge plates, a correction wheel sleeved on the correction assembly, and a reset assembly arranged below an end of the correction wheel close to the first bottom plate, where the correction wheel is coaxial with the correction assembly, the correction wheel entirely has a circular truncated cone structure, and a thickness of the circular truncated cone progressively decreases from a direction of the side edge plate to a direction of the first bottom plate.

As a preferred solution of the hub type energy storage mass block transport device according to the present invention, each of the guide parts includes guide plates symmetrically arranged on two sides above the second bottom plate, a storage groove formed in each of the guide plates, and a guide arc plate arranged at an end of each of the guide plates close to the first bottom plate, where a thickness of each of the guide plates is the same as a thickness of the trigger part, and an end of the limiting part extends into the storage grooves.

As a preferred solution of the hub type energy storage mass block transport device according to the present invention, the trigger part includes a movable bottom plate located between the two groups of guide plates, a connecting shaft arranged on two sides of an end of the movable bottom plate, a limiting groove formed below the movable bottom plate, and a supporting spring arranged below the movable bottom plate, where the connecting shaft extends towards two sides into the bearing part, and a tail end of the supporting spring extends into the second bottom plate.

As a preferred solution of the hub type energy storage mass block transport device according to the present invention, the locking part includes a vertical rod located on a side surface of the second bottom plate, a locking hook vertically arranged at a top end of the vertical rod in a horizontal direction, an adjusting groove formed at a lower position of the vertical rod, a triangular block arranged at a tail end of the vertical rod, and a limiting spring arranged between an inner side below the vertical rod and the second bottom plate, where an outer end of the fixed frame is located in the adjusting groove, and an end of the unlocking part abuts against a side surface of the triangular block.

As a preferred solution of the hub type energy storage mass block transport device according to the present invention, the limiting part includes linkage assemblies symmetrically arranged inside two sides of the second bottom plate, an active assembly arranged at outer ends of the linkage assemblies and located below an outer end of the movable bottom plate, and a limiting assembly arranged at the other ends of the linkage assemblies and extending upward into the storage grooves, where a top end of the active assembly abuts against a part below the movable bottom plate, a tail end of the active assembly downward penetrates through the second bottom plate, and a tail end of the limiting assembly downward penetrates through the first bottom plate.

As a preferred solution of the hub type energy storage mass block transport device according to the present invention, each of the linkage assemblies includes a connecting rod located in the second bottom plate, a first gear arranged at an outer end of the connecting rod, and a second gear arranged at the other end of the connecting rod, where an outer end of the first gear is engaged with a side surface of each of the linkage assemblies, an outer side of the second gear is engaged with a side surface of the limiting assembly, and a diameter of the first gear is less than a diameter of the second gear.

As a preferred solution of the hub type energy storage mass block transport device according to the present invention, the active assembly includes a vertical sliding rod arranged below the movable bottom plate in a vertical state and first teeth arranged on a side surface of the vertical sliding rod, where a top end of the vertical sliding rod abuts against a bottom surface of the movable bottom plate, and the first teeth are engaged with the first gear.

As a preferred solution of the hub type energy storage mass block transport device according to the present invention, the limiting assembly includes a vertical limiting rod arranged below the guide parts in a vertical direction, a transverse limiting rod arranged at a top end of the vertical limiting rod and located in the storage grooves, and second teeth arranged on a side surface of the transverse limiting rod, where the vertical limiting rod downward penetrates through the first bottom plate, and the second teeth are engaged with the second gear.

The present invention has the following beneficial effects: the hub type mass block can be locked and limited in the horizontal direction and be blocked and limited in left and right directions; and by limiting from three directions, the hub type mass block can be effectively prevented from accidentally falling in the transportation process, and the safety in the transportation process can be ensured.

### BRIEF DESCRIPTION OF DRAWINGS

To more clearly describe the technical solutions of the embodiments of the present invention, the accompanying drawings required to describe the embodiments are briefly described below. Apparently, the accompanying drawings described below are only some embodiments of the present invention. Those skilled in the art may further obtain other drawings based on these accompanying drawings without inventive effort. In the drawings:

FIG. 1 is a schematic structural diagram of a working state of a hub type energy storage mass block transport device according to the present invention;

FIG. 2 is a schematic structural diagram of an idle state of an idle state of a hub type energy storage mass block transport device according to the present invention;

FIG. 3 is a schematic diagram of an internal structure of a hub type energy storage mass block transport device according to the present invention;

FIG. 4 is a structural top view of a bearing part of a hub type energy storage mass block transport device according to the present invention;

FIG. 5 is a schematic structural diagram of an extruded state of a correction part of a hub type energy storage mass block transport device according to the present invention;

FIG. 6 is a schematic structural diagram of a correction part of a hub type energy storage mass block transport device according to the present invention when not being extruded;

FIG. 7 is a schematic structural diagram of a hub type energy storage mass block transport device according to the present invention when a mass block is locked;

FIG. 8 is a schematic structural diagram of a hub type energy storage mass block transport device according to the present invention during unlocking;

FIG. 9 is a schematic structural diagram of a mounting position of a limiting part of a hub type energy storage mass block transport device according to the present invention; and

FIG. 10 is a schematic structural diagram of a limiting part of a hub type energy storage mass block transport device according to the present invention.

### DETAILED DESCRIPTION OF THE EMBODIMENTS

To make the described objectives, features and advantages of the present invention more obvious and more understandable, the specific embodiments of the present invention are described in detail below in conjunction with the accompanying drawings.

A number of specific details are set forth in the description below to provide a thorough understanding for the present invention; however, the present invention may also be implemented in other manners different from those described herein, and those skilled in the art may make similar generalization without departing from the essence of the present invention; therefore, the present invention is not limited by the specific embodiments disclosed below.

Secondly, “one embodiment” or “embodiment” referred to herein refers to a specific feature, structure, or characteristic that may be included in at least one implementation manner of the present invention. The “in one embodiment” appearing in different parts of the present specification does not necessarily refer to the same embodiment, nor a separate or selective embodiment that is mutually exclusive to other embodiments.

Thirdly, the present invention is described in detail in conjunction with illustrations. When the embodiments of the present invention are described in detail, for ease of description, sectional views of the device structures are partially enlarged without being drawn to scale. The illustrations are merely exemplary and should not limit the protection scope of the present invention. Furthermore, the three-dimensional spatial dimensions of length, width and depth should be included in the actual production.

### Embodiment 1

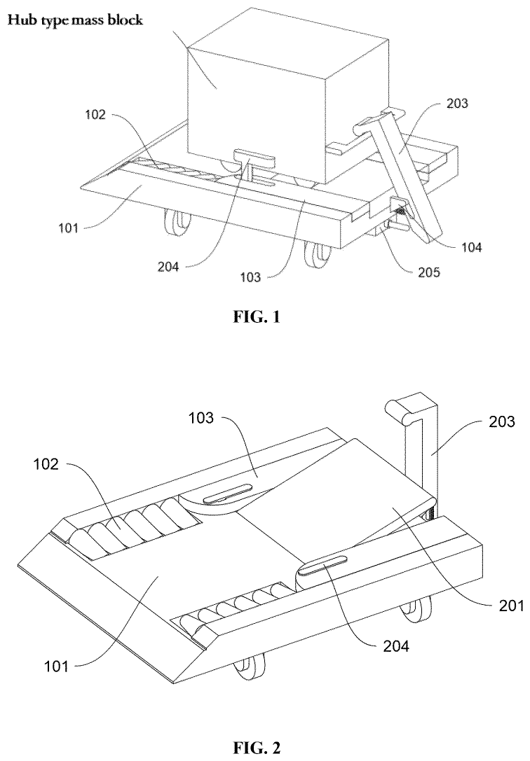

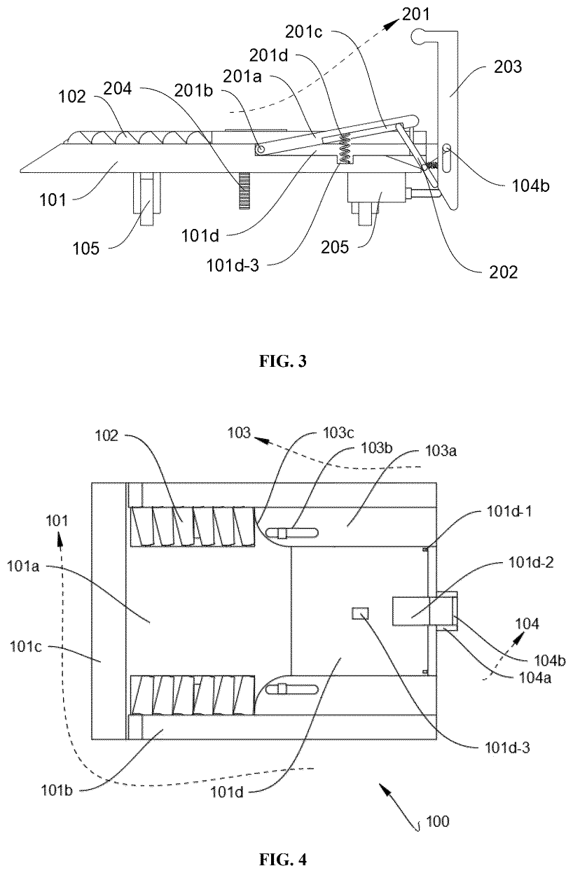

Referring to FIG. 1 to FIG. 3, which are a first embodiment of the present invention, a hub type energy storage mass block transport device is provided. The device includes: a bearing unit 100, including a bearing part 101 located below a hub type mass block, correction parts 102 symmetrically arranged on two sides of the bearing part 101, two groups of guide parts 103 arranged on two sides above the bearing part 101, and a fixed frame 104 arranged at an end of the bearing part 101, the guide parts 103 being fixedly connected to the bearing part 101, a moving wheel 105 for moving being further arranged below the bearing part 101, the hub type mass block being a mass block with a roller wheel below and capable of moving and having a trolley-shaped structure, and a hook for towing, pushing and pulling being arranged on a side surface of the mass block; and
a limiting unit 200, including a trigger part 201 located between the two groups of guide parts 103, a prying part 202 located on a side below the trigger part 201, a locking part 203 vertically arranged on a side surface of the bearing part 101, two groups of limiting parts 204 symmetrically distributed on two sides of the bearing part 101, and an unlocking part 205 arranged on a side below the bearing part 101, the fixed frame 104 being slidingly connected below the locking part 203, a top end of the unlocking part 205 abutting against an inner side of a tail end of the locking part 203, an end of the trigger part 201 being rotatably connected to the bearing part 101, the prying part 202 being located on an edge of a side of the bearing part 101, a top end of the prying part abutting against a part below the trigger part 201, the trigger part 201 being upwarped, the locking part 203 entirely having a reverse L-shaped structure and standing on a side surface of the bearing part 101, and the unlocking part 205 being fixedly connected to a bottom surface of the trigger part 201.

During use, the hub type mass block moves onto the bearing part 101, is corrected by the correction parts 102 to travel in a parallel displacement mode, and then is guided by the guide parts 103 onto the trigger part 201; the mass block located on the trigger part 201 will extrude the trigger part 201, so that the trigger part 201 rotates through the prying part 202, and the locking part 203 is pushed to rotate around the fixed frame 104 as an axis; a top end of the rotating locking part 203 will gradually approach the hook on the side surface of the mass block and finally clamp and hook the hook for hooking and locking; and the trigger part 201 moving downward will also synchronously push the limiting parts 204 to rise from two sides to protect and limit the two sides of the mass block, thereby ensuring the transportation safety of the mass block.

### Embodiment 2

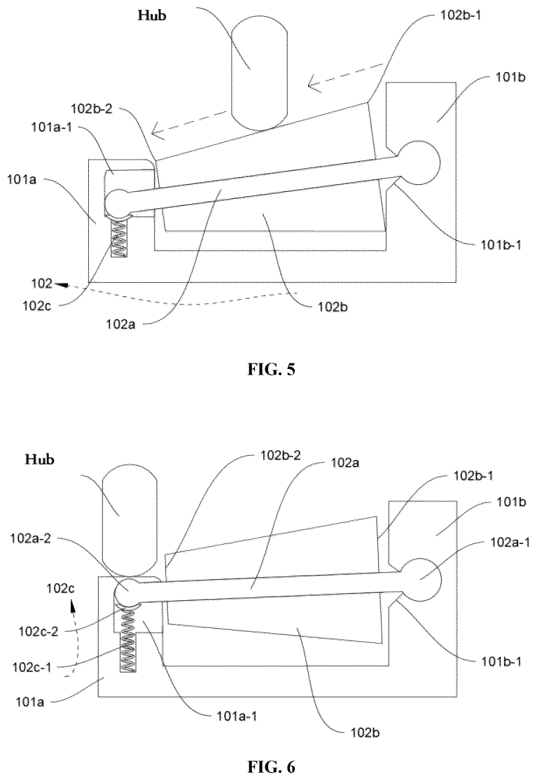

Referring to FIG. 4 to FIG. 6, which are a second embodiment of the present invention, this embodiment is different from the first embodiment in that: the mass block traveling to the device is guided to move on the bearing part 101 in a correct mode, thereby prevent the mass block from moving and deviating, avoiding the hidden danger of falling off the device and achieving a function of correcting and guiding.

Compared with Embodiment 1, further, the bearing part 101 includes a first bottom plate 101a located between the two groups of correction parts 102, side edge plates 101b symmetrically arranged on two sides of the first bottom plate 101a, a guide plate 101c arranged at one end of the first bottom plate 101a, and a second bottom plate 101d arranged at the other end of the first bottom plate 101a, where the correction parts 102 are mounted between the first bottom plate 101a and the side edge plates 101b; the guide plate 101c has a triangular structure, and the highest part of the hypotenuse of the triangle is connected to a top surface of the first bottom plate 101a, so that the mass block can move onto the bearing part 101 conveniently; a top surface of the second bottom plate 101d is lower than the top surface of the first bottom plate 101a; the first bottom plate and the second bottom plate are not located on at the same level, and a distance between the first bottom plate and the second bottom plate is a thickness of the trigger part 201; and when the trigger part 201 is attached to the second bottom plate 101d, the first bottom plate 101a and a top surface of the trigger part 201 are at the same level.

Further, two groups of slots 101d-1 are formed in the second bottom plate 101d, the active assembly 204b passes through the slots, a third clearance groove 101d-2 is formed at the position of the second bottom plate 101d close to the prying part 202, the third clearance groove 101d-2 is obliquely formed, the inclination mode limits the rotating range of the prying part 202, an accommodating groove 101d-3 is formed at the center of the second bottom plate 101d, and a supporting spring 201d is located in the accommodating groove, so that the supporting spring 201d can be stored.

Each of the correction parts 102 includes a correction assembly 102a located between the first bottom plate 101a and the side edge plates 101b, a correction wheel 102b sleeved on the correction assembly 102a, and a reset assembly 102c arranged below an end of the correction wheel 102b close to the first bottom plate 101a, where the correction wheel 102b is coaxial with the correction assembly 102a, the correction wheel 102b entirely has a circular truncated cone structure, a thickness of the circular truncated cone progressively decreases from a direction of the side edge plate 101b to a direction of the first bottom plate 101a, and each of the correction parts 102 is rotatably connected between the first bottom plate 101a and the side edge plates 101b through the correction assembly 102a.

Further, a second limiting ball 102a-2 and a first limiting ball 102a-1 are respectively arranged at two ends of the correction assembly 102a, the first limiting ball 102a-1 and the second limiting ball 102a-2 respectively extend into the side edge plates 101b and the first bottom plate 101a, the side edge plates 101b and the first bottom plate 101a are correspondingly provided with a second clearance groove 101b-1 and a first clearance groove 101a-1 for storage, and the second clearance groove 101b-1 has a trumpet-shaped opening, thereby meeting that the correction assembly 102a rotates up and down in a vertical direction around the first limiting ball 102a-1 as an axis.

Further, the first clearance groove 101a-1 has a rectangular structure, the reset assembly 102c is mounted below an interior of the first clearance groove, the second limiting ball 102a-2 is located in the first clearance groove 101a-1, and a part of the correction assembly 102a also extends into the first clearance groove 101a-1; when the correction assembly 102a rotates around the first limiting ball 102a-1 as an axis, the first clearance groove 101a-1 can provide a moving space for the second limiting ball 102a-2 and the correction assembly 102a; and the correction wheel 102a entirely has a circular truncated cone structure, two ends of the circular truncated cone structure are flat planes, an end with a smaller diameter is a small-diameter end 102b-2, an end with a bigger diameter is a big-diameter end 102b-1, and the small-diameter end 102b-2 is close to the first bottom plate 101a.

During use, the reset assembly 102c includes a reset spring 102c-1 located in the first clearance groove 101a-1, and a supporting sheet 102c-2 arranged at a top end of the reset spring 102c-1, where the supporting sheet 102c-2 abuts against and is supported below the second limiting ball 102a-2, and the second limiting ball 102a-2 can be jacked up through the elastic support of the reset spring 102c-1.

Each of the guide parts 103 includes guide plates 103a symmetrically arranged on two sides above the second bottom plate 101d, storage grooves 103b formed in the guide plates 103a, and guide arc plates 103c arranged on the guide plates 103a close to an end of the first bottom plate 101a, where a thickness of each of the guide plates 103a is the same as that of the trigger part 201, an end of the limiting part 204 extends into the storage grooves 103b, inner side edges of the guide plates 103a abut against two sides of the trigger part 201, the guide arc plates 103c have arc-shaped structures, tail ends of the arc-shaped structures are in butt joint with the inner side edges of the guide plates 103a, and an object guided by the guide arc plates 103c will move onto the trigger part 201.

During use, a hub below the mass block which moves onto the device in a skew state will move and crush on the correction wheel 102b, and the extruded correction parts 102 will extrude the reset assembly 102c to shrink, so that the correction parts 102 entirely rotate around the first limiting ball 102a-1 as an axis, and an end of the small-diameter end 102b-2 will incline to a side surface of the first bottom plate 101a at this time; with the continuous movement of the mass block, the correction wheel 102b of the circular truncated cone structure will guide the hub of the mass block inward, so that the hub will slide down to the first bottom plate 101a along with an outer wall of the correction wheel 102b; the hub sliding down to the first bottom plate 101a will not extrude the correction parts 102 any more, and at this time, the reset assembly 102c rebounds upward to jack up the second limiting ball 102a-2, so that the correction parts 102 reset entirely; meanwhile, a side surface of the small-diameter end 102b-2 will be parallel to a side edge of the first bottom plate 101a; when the hub deflects to the side surface again, the side surface of the hub will abut against the side surface of the small-diameter end 102b-2, so that the hub cannot move onto the correction wheel 102b and only can continuously move on the first bottom plate 101a; therefore, the skew mass block can be guide to a correct position through the correction parts 102, deflection of the mass block moving on the first bottom plate 101a can be avoided, and the safety and normal operation can be ensured.

The remaining structure is the same as the structure in Embodiment 1.

### Embodiment 3

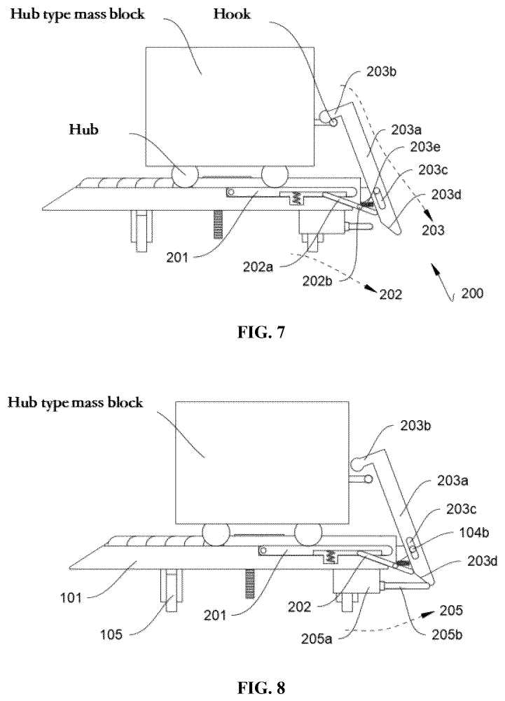

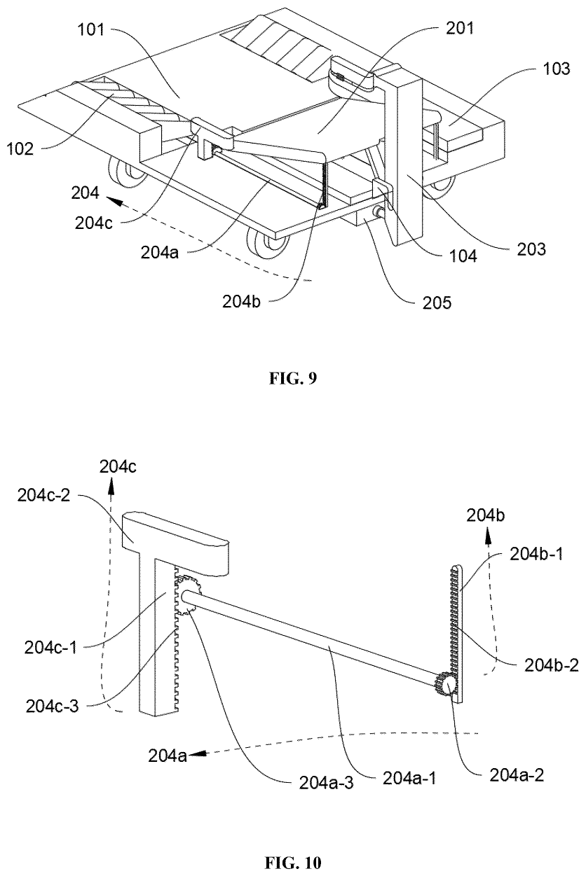

Referring to FIG. 7 to FIG. 10, which are a third embodiment of the present invention, this embodiment is different from the second embodiment in that: the mass block is limited and protected from three directions, thereby preventing the mass block from falling off and displacing during movement, and ensuring the transportation safety of the mass block.

Compared with Embodiment 2, further, the trigger part 201 includes a movable bottom plate 201a located between the two groups of guide plates 103a, a connecting shaft 201b arranged on two sides of an end of the movable bottom plate 201a, a limiting groove 201c formed below the movable bottom plate 201a, and a supporting spring 201d arranged below the movable bottom plate 201a, where the connecting shaft 201b extends toward two sides into the bearing part 101, a tail end of the supporting spring 201d extends into the second bottom plate 101d, the movable bottom plate 201a can rotate on the bearing part 101 around the connecting shaft 201b as an axis, and the supporting spring 201d located between the second bottom plate 101d and the movable bottom plate 201a can support the trigger part 201 upward entirely through elastic support.

Further, the prying part 202 includes a lever 202a located in the slots 101d-1, and a rotating shaft 202b arranged on two sides of the lever 202a, where a top end of the lever 202a abuts against a bottom surface of the movable bottom plate 201a, a tail end of the lever abuts against an inner side below a vertical rod 203a; and the unlocking part 205 includes an air cylinder 205a fixedly connected below the second bottom plate 101d, and a push rod 205b arranged on a side surface of the air cylinder 205a, where the push rod 205b abuts against a side surface of a triangular block 203d.

The locking part 203 includes the vertical rod 203a located on a side surface of the second bottom plate 101d, a locking hook 203b vertically arranged at a top end of the vertical rod 203a in a horizontal direction, an adjusting groove 203c formed at a lower position of the vertical rod 203a, the triangular block 203d arranged at a tail end of the vertical rod 203a, and a limiting spring 203e arranged between an inner side below the vertical rod 203a and the second bottom plate 101d, where an outer end of the fixed frame 104 is located in the adjusting groove 203c, an end of the unlocking part 205 abuts against a side surface of the triangular block 203d, the triangular block 203d has a triangular structure, and the unlocking part 205 abuts against a hypotenuse of the triangular block 203d.

Further, the fixed frame 104 includes two groups of fixed blocks 104a mounted on a side surface of the bearing part 101, and a fixed shaft 104b arranged between the fixed blocks 104a, where the fixed shaft 104b is located in the adjusting groove 203c to limit the locking part 203; when the limiting spring 203e pulls back the vertical rod 203a inward, the vertical rod 203a will rotate around the fixed shaft 104b in the adjusting groove 203a as a circle center; and with the abutment of a tail end of the lever 202a, the locking part 203 will be entirely in a vertical state in a conventional state.

During use, when the mass block is corrected and guided by the correction parts 102 and the guide parts 103 to move onto the movable bottom plate 201a, the movable bottom plate 201a is extruded by the weight of the mass block to rotate downward around the connecting shaft 201b as an axis, the downward rotating movable bottom plate 201a will compress the supporting spring 201d to shrink and accumulate energy, and a top end abuts against the prying part 202 below the movable bottom plate 201a; when performing downward extrusion, the movable bottom plate 201a rotates around the rotating shaft 202b as an axis, and at this time, the downward pressing movable bottom plate 201a will push the whole locking part 203 from an inner side below the locking part 203 through the lever 202a in the form of the lever, so that the locking part 203 will rotate inward around the fixed shaft 104b as an axis, and a locking hook 203b at a top end of the rotating locking part 203 will be finally clamped and locked on the hook of the mass block, thereby achieving limiting in the horizontal direction and a locking function; when unlocking is required, an instruction is sent to the air cylinder 205a, the air cylinder 205a will push the push rod 205b outward, the outward pushed push rod 205b will abut against and be pushed on the triangular block 203d; due to the inclined surface structure of the triangular block 203d, when the push rod 205b extends out in the horizontal direction, an upward thrust can be applied to the whole locking part 203 through the triangular block 203d, so that the locking part 203 entirely moves upward; and the locking hook 203b at the top end will be separated from the hook, so that an unlocking function is achieved, and the mass block can slide on the device in the horizontal direction.

The limiting part 204 includes linkage assemblies 204a symmetrically arranged inside two sides of the second bottom plate 101d, an active assembly 204b arranged at outer ends of the linkage assemblies 204a and located below an outer end of the movable bottom plate 201a, and a limiting assembly 204c arranged at the other ends of the linkage assemblies 204a and extending upward into the storage grooves 103b, where a top end of the active assembly 204b abuts against a part below the movable bottom plate 201a, a tail end of the active assembly downward penetrates through the second bottom plate 101d, and a tail end of the limiting assembly 204c downward penetrates through the first bottom plate 101a.

Each of the linkage assemblies 204a includes a connecting rod 204a-1 located in the second bottom plate 101d, a first gear 204a-2 arranged at an outer end of the connecting rod 204a-1, and a second gear 204a-3 arranged at the other end of the connecting rod 204a-1, where an outer end of the first gear 204a-2 is engaged with a side surface of each of the linkage assemblies 204a, an outer side of the second gear 204a-3 is engaged with a side surface of the limiting assembly 204c, a diameter of the first gear 204a-2 is less than a diameter of the second gear 204a-3, and the first gear 204a-2 is coaxial with the second gear 204a-3, so when the first gear 204a-2 rotates coaxially with the second gear 204a-3, a movement perimeter of the first gear 204a-2 is less than that of the second gear 204a-3.

The active assembly 204b includes a vertical sliding rod 204b-1 arranged below the movable bottom plate 201a in a vertical state and first teeth 204b-2 arranged on a side surface of the vertical sliding rod 204b-1, where a top end of the vertical sliding rod 204b-1 abuts against a bottom surface of the movable bottom plate 201a, and the first teeth 204b-2 are engaged with the first gear 204a-2; and through the engagement of the first teeth 204b-2 and the first gear 204a-2, the first gear 204a-2 will be driven to rotate when the active assembly 204b moves in the vertical direction.

The limiting assembly 204c includes a vertical limiting rod 204c-1 arranged below the guide parts 103 in the vertical direction, a transverse limiting rod 204c-2 arranged at a top end of the vertical limiting rod 204c-1 and located in the storage grooves 103b, and second teeth 204c-3 arranged on a side surface of the transverse limiting rod 204c-2, where the vertical limiting rod 204c-1 downward penetrates through the first bottom plate 101a, and the second teeth 204c-3 are engaged with the second gear 204a-3; and through the engagement of the second teeth 204c-3 and the second gear 204a-3, the limiting assembly 204c can be driven to slide in the vertical direction when the second gear 204a-3 rotates.

During use, the first gear 204a-2 rotates coaxially with the second gear 204a-3, the active assembly 204b is located on a right side of the first gear 204a-2, and the limiting assembly 204c is located on a right side of the second gear 204a-3. Therefore, when the linkage assemblies 204a rotate clockwise, the linkage assemblies 204a apply a downward pulling force to the active assembly 204b through the first gear 204a-2, and apply an upward extending force to the limiting assembly 204c through the second gear 204a-3 at the other end. When the trigger part 201 is extruded by the weight of the mass block and moves downward, the movable bottom plate 201a will press the active assembly 204b to move downward, the downward moving active assembly 204b will drive the first gear 204a-2 through the first teeth 204b-2 to rotate, the rotating first gear 204a-2 will drive the linkage assemblies 204a to rotate entirely, the rotating linkage assemblies 204a will push the limiting assembly 204c upward through the second gear 204a-3, the limiting assemblies 204c on two sides extend upward at the same time, and the mass block can be limited and protected from two sides of the ass block, thereby preventing the mass block from toppling to two sides of the device and further ensuring the safety of the mass block in the transportation process.

The remaining structure is the same as the structure in Embodiment 2.

Importantly, it should be noted that the constructions and arrangements of the present application shown in a plurality of different exemplary implementation solutions are merely exemplary. Although only a few implementation solutions are described in detail in the contents disclosed herein, those having reference to the contents disclosed herein should readily understand that many modifications are possible (for example, variations in the sizes, dimensions, structures, shapes and proportions of various elements, parameter values (such as temperatures and pressures), installations and arrangements, use of materials, colors, orientations, etc.), without materially departing from the novel teachings and advantages of the subject described in the present application. For example, the elements shown as integrally formed may be constructed of a plurality of parts or elements, the positions of the elements may be inverted or varied in other manners, and the properties, quantities or positions of the discrete elements may be altered or varied. Therefore, all such modifications are intended to be included within the scope of the present invention. The order or sequence of any process or method steps may be changed or re-sequenced according to alternative embodiments. In the claims, any provision of “device+function” is intended to cover the structure described herein to perform the described function, and is not only structurally equivalent but also equivalently structured. Other substitutions, modifications, changes and omissions may be made in the design, operation and arrangement of the exemplary implementation schemes without departing from the scope of the present invention. Therefore, the present invention is not limited to a specific implementation scheme, but extends to various modifications that come within the scope of the appended claims.

In addition, for a concise description of the exemplary implementation solutions, all features of actual embodiments (that is, those that are not related to the currently considered best mode for carrying out the present invention, or those that are not related to the practice of the present invention) may not be described.

It should be noted that the above embodiments are merely used to describe, but not to limit, the technical solution of the present invention. Although the present invention is described in detail with reference to the preferred embodiments, those of ordinary skill in the art should understand that the technical solution of the present invention can be modified or equivalently replaced without departing from the spirit and scope of the technical solution of the present invention, and should be included in the scope of the claims of the present invention.

What is claimed is:

1. A hub type energy storage mass block transport device, comprising:
a bearing unit, comprising a bearing part located below a hub type mass block, correction parts symmetrically arranged on two sides of the bearing part, two groups of guide parts arranged on two sides above the bearing part, and a fixed frame arranged at an end of the bearing part; and
a limiting unit, comprising a trigger part located between the two groups of guide parts, a prying part located on a side below the trigger part, a locking part vertically arranged on a side surface of the bearing part, two groups of limiting parts symmetrically distributed on two sides of the bearing part, and an unlocking part arranged on a side below the bearing part, the fixed frame being slidingly connected below the locking part, and a top end of the unlocking part abutting against an inner side of a tail end of the locking part.

2. The hub type energy storage mass block transport device according to claim 1, wherein the bearing part comprises a first bottom plate located between the two groups of correction parts, side edge plates symmetrically arranged on two sides of the first bottom plate, a guide plate arranged at one end of the first bottom plate and a second bottom plate arranged at the other end of the first bottom plate, the correction parts being mounted between the first bottom plate and the side edge plates.

3. The hub type energy storage mass block transport device according to claim 2, wherein each of the correction parts comprises a correction assembly located between the first bottom plate and the side edge plates, a correction wheel sleeved on the correction assembly, and a reset assembly arranged below an end of the correction wheel close to the first bottom plate, the correction wheel being coaxial with the correction assembly, the correction wheel entirely having a circular truncated cone structure, and a thickness of the circular truncated cone progressively decreasing from a direction of the side edge plate to a direction of the first bottom plate.

4. The hub type energy storage mass block transport device according to claim 3, wherein each of the guide parts comprises guide plates symmetrically arranged on two sides above the second bottom plate, a storage groove formed in each of the guide plates, and a guide arc plate arranged at an end of each of the guide plates close to the first bottom plate, a thickness of each of the guide plates being the same as a thickness of the trigger part, and an end of the limiting part extending into the storage grooves.

5. The hub type energy storage mass block transport device according to claim 4, wherein the trigger part comprises a movable bottom plate located between the two groups of guide plates, a connecting shaft arranged on two sides of an end of the movable bottom plate, a limiting groove formed below the movable bottom plate, and a supporting spring arranged below the movable bottom plate, the connecting shaft extending towards two sides into the bearing part, and a tail end of the supporting spring extending into the second bottom plate.

6. The hub type energy storage mass block transport device according to claim 5, wherein the locking part comprises a vertical rod located on a side surface of the second bottom plate, a locking hook vertically arranged at a top end of the vertical rod in a horizontal direction, an adjusting groove formed at a lower position of the vertical rod, a triangular block arranged at a tail end of the vertical rod, and a limiting spring arranged between an inner side below the vertical rod and the second bottom plate, an outer end of the fixed frame being located in the adjusting groove, and an end of the unlocking part abutting against a side surface of the triangular block.

7. The hub type energy storage mass block transport device according to claim 6, wherein the limiting part comprises linkage assemblies symmetrically arranged inside two sides of the second bottom plate, an active assembly arranged at outer ends of the linkage assemblies and located below an outer end of the movable bottom plate, and a limiting assembly arranged at the other ends of the linkage assemblies and extending upward into the storage grooves, a top end of the active assembly abutting against a part below the movable bottom plate, a tail end of the active assembly downward penetrating through the second bottom plate, and a tail end of the limiting assembly downward penetrating through the first bottom plate.

8. The hub type energy storage mass block transport device according to claim 7, wherein each of the linkage assemblies comprises a connecting rod located in the second bottom plate, a first gear arranged at an outer end of the connecting rod, and a second gear arranged at the other end of the connecting rod, an outer end of the first gear being engaged with a side surface of each of the linkage assemblies, an outer side of the second gear being engaged with a side surface of the limiting assembly, and a diameter of the first gear being less than a diameter of the second gear.

9. The hub type energy storage mass block transport device according to claim 8, wherein the active assembly comprises a vertical sliding rod arranged below the movable bottom plate in a vertical state and first teeth arranged on a side surface of the vertical sliding rod, a top end of the vertical sliding rod abutting against a bottom surface of the movable bottom plate, and the first teeth being engaged with the first gear.

10. The hub type energy storage mass block transport device according to claim 9, wherein the limiting assembly comprises a vertical limiting rod arranged below the guide parts in a vertical direction, a transverse limiting rod arranged at a top end of the vertical limiting rod and located in the storage grooves, and second teeth arranged on a side surface of the transverse limiting rod, the vertical limiting rod downward penetrating through the first bottom plate, and the second teeth being engaged with the second gear.
